(19) United States
(12) Patent Application Publication
(10) Pub. No.: US 2008/0072142 A1
(43) Pub. Date: Mar. 20, 2008

(54) Code transformation method for an operation system

(75) Inventor: Eric Yao, Shanghai (CN)

Correspondence Address: BIRCH STEWART KOLASCH & BIRCH, PO BOX 747, FALLS CHURCH, VA, 22040-0747, US

(73) Assignee: Inventec Appliances Corp., Taipei (TW)

(21) Appl. No.: 11/898,788

(22) Filed: Sep. 14, 2007

(30) Foreign Application Priority Data
Sep. 15, 2006 (TW) 95134373

(51) Int. Cl. G06F 3/14

(52) U.S. Cl. 715/256

(57) ABSTRACT

A code transforming method is provided for use in an operation system of a computer prior to displaying and printing out a text document and includes the steps: (i) transforming content of the text document into a temporary text file utilizing a data transformation service; (ii) coding each character of the temporary text file into a sequence of 16-bit words; (iii) encoding the sequence of 16-bit words in accordance with a transformation table for displaying or printing; and (iv) outputting the encoded sequence of 16-bit words to a Dynamic Link Library in order to display or printout the text document.

### FIELD OF THE INVENTION

The invention relates to a method for encoding and decoding a character, and more particularly to a math function and method for encoding/decoding the character, whereby an output device does not generate or display garbage characters.

### BACKGROUND OF THE INVENTION

Due to the culture and region, it generally happens that the same character is encoded in several different ways in several encoding systems. To be more specific, two encoding systems can use the same number for two different characters or used different numbers for the same character. For a computer set, in case the codes for encoding the characters are different from those preset codes unrecognizable by the operation system in the computer, the latter will produce an illegible content on a display device or a printer. The characters are therefore required to undergo transformation of codes so as to be recognized by the computer set in order to produce a legible content.

The computer set is invented by the United States in the earlier time. The text document is generally composed of 26 English Letters (including capital and small) in combination with some symbols and signs, and some control marks of the computer system. In the earlier time, only 7 bits are required for assigning a byte set in order to present an individual character in the text document. The standard ASCII character set has been adopted to use in the computer set. According to the Standard ASCII Character Set, each binary value between 0 and 127 is given a specific character, a total of 128 characters.

Regarding European languages, the byte set formed by 7 bits is insufficient because European languages includes a plurality of Latin alphabets and upper and lower symbols for specific Letters in addition to 26 English Letters of the Standard ASCII Character Set. Therefore, the aforesaid encoding system needs to be extended. Then comes the ISO 8895, a standard character encoding system for Latin alphabets, which uses eight-bit coded character sets.

For languages used in Asian countries, the ISO 8895 Encoding System cannot conform to the structure of Asian languages, since no spelling method is used to form the characters of these countries. The encoding system requires an extra of several thousand punctuations or technical symbols in order to solve the problems encountered when encoding the Chinese Characters alone. A combination of several bytes is used to encode a specific symbol. Presently, Big5 standard (an encoding method) is utilized for encoding Traditional Chinese characters used in Taiwan and Hong Kong. A double-byte character set is used for encoding an individual character. However, when two languages (Chinese and English) are incorporated within a text document, a particular system is required to partition the text document into separate blocks, one is to be treated in accordance with the Standard ASCII Character Set while the other is treated by the Big5. A rule or principle is required to distinguish whether one byte unit is to be regarded as one character according to the ASCII Character Set or is to be combined with the following byte unit according to the BIG5 Character Set.

Under certain circumstance, the content of a single text document includes multilingual characters, i.e. a specification in Chinese version simultaneously includes Chinese characters encoded according to Big5 and English words encoded according to the Standard ASCII Character Set, the two encoding systems does not conflict with each other. In case, the same text document includes more than two languages, such as Chinese, Japanese and Korean characters, and when the printer, connected to a PC, prints out the text document, garbage characters will be generated. The reason resides in that the encoding system for one writing method of one language differs from one another and the data base of the PC installed with Windows Operation System in Chinese Version only includes Big5, which enables to recognize the Chinese characters only and not the Korean Characters. Some software installed within the PC may transform these languages into several encoding systems, thereby disposing the printer in a condition, in which, the printer is unable to recognize the encoded characters such that the printout is in a state of garbage characters.

### SUMMARY OF THE INVENTION

Therefore, it is the object of the present invention to provide a software to be installed into a computer set provided with whatever the operation system, thereby permitting the computer set to produce an accurate text document regardless of whatever language the text is written.

It is an another object of the present invention is to effectively solve the conflicts among the encoding systems encountered by the conventional computer set.

According to the present invention, a code transforming method is provided for use in an operation system of a computer prior to displaying and printing out a text document. The method includes the steps: (i) transforming content of the text document into a temporary text file utilizing a data transformation service; (ii) coding each character of the temporary text file into a sequence of 16-bit words; (iii) encoding the sequence of 16-bit words in accordance with a transformation table for displaying or printing; and (iv) outputting the encoded sequence of 16-bit words to a Dynamic Link Library in order to display or printout the text document.

When compared to the prior art technology, the code transformation method of the present invention can eliminate the garbage characters outputted by a printer or a display device due to the conflicts among the encoding systems for multilingual characters of several languages.

### BRIEF DESCRIPTION OF THE DRAWING

Other features and advantages of this invention will become more apparent in the following detailed description of the preferred embodiment of this invention, with reference to the accompanying drawings, in which:

FIG. 1 is a block diagram illustrating the preferred embodiment of a code transforming method of the present invention;

FIG. 2 is a flowchart illustrating steps of the code transforming method of the present invention; and

FIG. 3 illustrates how a Chinese character in the Operation System of Chinese Version is transformed into a Korean character by the code transformation method of the present invention.

### DETAILED DESCRIPTIONS OF THE PREFERRED EMBODIMENT

The object of the present invention is to provide a code transformation method (a code transformation software) for using in a computer set. The computer set (with the presently installed operation system and the encoding system) is thus enabled to encode the content of a desired text of any writing system that can be recognized by an output device such that the output device can smoothly output the desired text.

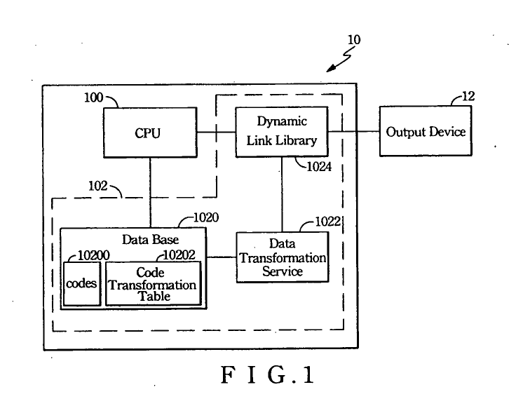

FIG. 1 shows a block diagram illustrating the preferred embodiment of a computer system of the present invention. The computer system includes a PC 10 and an output device 12, wherein the PC 10 consists of a central processing unit (CPU) 100 and an operation system 102. The operation system 102 includes a Data Base 1020, a Data Transformation Service (DTS) 1022 and a Dynamic Link Library (DLL) 1024, wherein a plurality of codes 10200 and a Code Transformation Table 10202 are stored within the Data Base 1020 in advance so as to be implemented by the Operation System for encoding characters. The Dynamic Link Library (DLL) 1024 is used for storing a temporary file of a text document to be printed out later. A detailed disclosure of the code transformation method of the present invention is given in the following paragraphs.

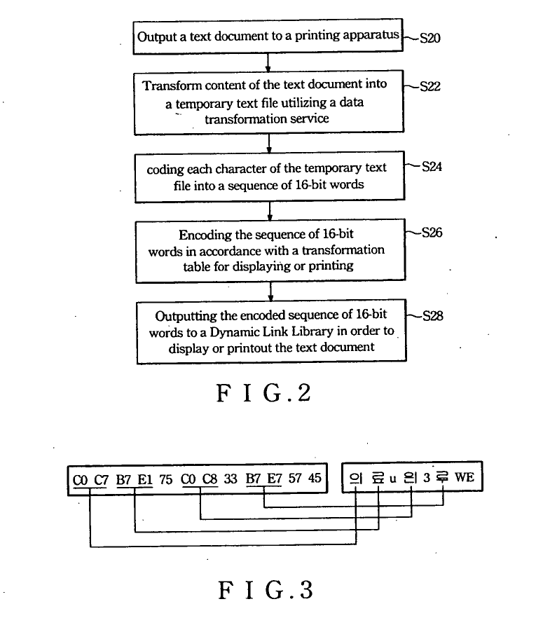

FIG. 2 is a flowchart illustrating steps of the code transforming method of the present invention. In case the design parameters of the hardware device and the bit sequence of the Operation System are not compatible to one another, the computer may produce an error during the input and/or output operation. In order to avoid this problem, the PC must undergo a certain code transformation process so as to be compatible with the encoding system employed with the output device. A printing apparatus serves as the output device in this embodiment.

The encoding system of the present Operation System and the output device includes the same codes or code sets for encoding character. The code transformation process is carried out utilizing the Data Transformation Service, and those codes 10200 stored within the Data Base in combination with the software of the present invention. Fundamentally, those code 10200 stored within the Data Base are formed according to the Unicode Standard and serve as the basic codes or code set for the software of the present invention. No limitation should be set for the basic codes or code set. Alternately, the basic codes or code set can be formed in accordance with USC4. The basic code set preferably includes numbers, symbols, representative marks for encoding systems of writing methods of multilingual characters of any regions or countries. When the basic code set is thus arranged, we can encode and transform the characters of any writing method.

According to step 10: it is desired to print out a text document by the PC via the printing apparatus, and it is discovered that the encoding system for the characters of the text document conflicts with that of the printing apparatus. According to step 12: the software of the present invention will transform the content of the text document into a temporary file by the Data Transformation Service. Since the Data Transformation Service is also utilized for printout, the content of the output document is not produce in garbage characters i.e. is legible. According to step 14: the math function in the software of the present invention will transform the codes of the Operation System for coding the characters into the codes compatible to the basic code set, i.e. each character is represented by a sequence of 16-bit words of the Unicode Standard. According to step 16: encode the sequence of 16-bit words in such a manner to conform with the encoding system of the printing apparatus, wherein an appropriate code transformation table is present between the encoding system of the printing apparatus and the Unicode Standard. Utilizing this code transformation table, it is quite easy to transform the codes of the Unicode Standard into ones recognizable by the encoding system of the printing apparatus.

Finally, the content (decoded) of the text document is transmitted to the Dynamic Link Library, where a print control command is sorted for commanding the encoding system of the printing apparatus in order to permit the printout of the text document.

According to the present invention, the codes 10200 stored within the Data Base 1020 enable the same software to process multilingual characters of any languages or regions, and therefore is compatible to the encoding system of all writing method of multilingual characters No amendment is required for the software. Under this condition, the transformation interface (the software) is responsible inter-transformation of the codes between the Operation System and the basic code set of the Unicode Standard. The outmost task of the transformation interface is to process the multilingual characters, permitting inter-transformation of the codes among multilingual characters. The software written according to the present invention can support the Operation System under any environments regardless of the encoding system for any writing methods.

FIG. 3 illustrates how a Chinese character in the Operation System of Chinese Version is transformed into a Korean character by the code transformation method of the present invention. Because the BIG 5 for character encoding method for Traditional Chinese character is different from the encoding method for the Korean characters, the printing apparatus may produce garbage characters. Each Korean character is transformed with the assistance of the transformation interface of the present invention into a wide character (represented in byte set), so as to enable the Operation System to process the same.

Each character is encoded in sequence of 16 bit set of the Unicode Standard (see the left side in FIG. 3) to be compatible to the Korean character. For instance, a two-byte Korean character (see the first one in the right side of FIG. 3) is coded as—Co-C7, while the single “Letter” of English Alphabets, punctuation, or counting number is coded and 00 is added at the big-end, thereby achieving—00-75, and the same is transmitted to the Dynamic Link Library. Eventually, the byte set received by the printing apparatus is represented by C0C7B7E10075C0C80033B7E700570045, thereby enabling the printing apparatus to print out the Korean character shown on the right side of FIG. 3. Under the Korean language environment, the content in Korean version includes Korean characters, words or symbols in accordance with the Standard ASCII Character Set.

Note that after the content of the text document is transformed by the Data Transformation Service into the temporary text file, the latter is coded by the software of the present invention. In order to accomplish the task, each character is coded into the code included within the basic code set, which later undergoes transformation by means of the Code Transformation Table, thereby ensuring smooth transformation and obtaining a text in the required characters.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A code transforming method for use in an operation system of a computer prior to displaying and printing out a text document, comprising:
transforming content of the text document into a temporary text file utilizing a data transformation service;
coding each character of said temporary text file into a sequence of 16-bit words;
encoding said sequence of 16-bit words in accordance with a transformation table for displaying or printing;
outputting said encoded sequence of 16-bit words to a Dynamic Link Library in order to display or printout the text document.

2. The method according to claim 1, wherein said encoded sequence of 16-bit words includes a plurality of unique numbers compiled according to the Unicode Standard.

3. The method according to claim 1, wherein said transformation table is compatible to a printing character of a printer being used so as to result in the text document.

4. The method according to claim 1, wherein said content of the text document includes multilingual characters.

5. The method according to claim 1, wherein said transformation table includes a specific character conforming to said character represented by said sequence of 16-bit words.

6. The method according to claim 1, wherein a character represented by said sequence of 16-bit words is encoded according to USC4 standard.

7. The method according to claim 1, wherein the computer includes a data base and wherein said transformation table is stored within said data base.
